(19) United States
(12) Patent Application Publication
(10) Pub. No.: US 2026/0310844 A1
(43) Pub. Date: Oct. 8, 2026

(54) SYSTEM AND METHOD FOR DESIGNING POSITION OF VENTILATION INLET BY USING AIR AGE PREDICTION MODEL

(71) Applicant: IUCF-HYU (INDUSTRY-UNIVERSITY COOPERATION FOUNDATION HANYANG UNIVERSITY), Seoul (KR)

(72) Inventors: Hongyun SO, Seoul (KR); Keuntae BAEK, Seoul (KR); Sanghun SHIN, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/634,824

(22) Filed: Mar. 31, 2026

(30) Foreign Application Priority Data
Apr. 3, 2025 (KR) 10-2025-0043665

(51) Int. Cl. G06F 30/18

(52) U.S. Cl. CPC G06F 30/18

(57) ABSTRACT

The present invention relates to a system and a method for designing a position of a ventilation inlet by using an air age prediction model. According to the present invention, the system for designing the position of the ventilation inlet by using the air age prediction model includes: a data input unit for inputting position information of a group of candidates for the ventilation inlet based on a position of a facility within a target space; and a ventilation inlet position determination unit for determining an installation position of the ventilation inlet by using information of the facility and the position information of the group of candidates for the ventilation inlet as input data, and outputting mean air age data at a periphery of the facility according to a variation in a flow velocity of air introduced into the ventilation inlet to the air age prediction model.

### BACKGROUND OF THE INVENTION

### 1. Field of the Invention

The present invention relates to a technology for designing a position of a ventilation inlet, and more particularly, to a system and a method for designing and optimizing a position of a ventilation inlet so as to efficiently manage indoor air quality within a specific space by utilizing a machine learning-based air age prediction model.

### 2. Description of the Related Art

Since most people spend a significant amount of time indoors while working or resting, there is growing interest in a method for optimizing an indoor environmental condition, which is a major factor affecting comfortableness, health, and productivity of people. Key elements of indoor environmental quality (IEQ) include thermal conditions, air quality, and visual and acoustic elements, all of which affect residents.

Until now, various attempts have been made to optimize IEQ elements of an entire building space in order to improve an indoor environment. However, as it is recognized that individual users have different preferences for the IEQ elements, recent researches are increasingly focusing on a personalized environmental control system (PECS). Indoor environmental conditions preferred by individuals may be adjusted by applying the PECS to actual environments so that comfortableness, health, and productivity may be improved. Such a PECS concept is expected to be effectively used in hospital wards in order to assist recovery of a patient and reduce transmission of diseases among patients.

In a case of highly contagious respiratory diseases in hospital wards, viruses spread into the air when infected patients speak, breathe, or cough, and the spread of viruses may be minimized by properly managing indoor air quality (IAQ), which refers to air quality within a building, among the IEQ elements. In general, in order to improve the IAQ within the building, ventilation performance has to be enhanced by controlling heating, ventilation, and air conditioning (HVAC) to improve an air flow and an air variation rate. However, simply increasing an HVAC operating rate may be highly inefficient due to high energy consumption while improving the IAQ. Therefore, in order to implement an effective and efficient method for improving IAQ, it is necessary to optimize the IAQ with minimal energy by accurately measuring the IAQ within the building and adjusting operating conditions of the HVAC.

Among various elements of the IAQ, a mean age of air (MAA) refers to an average lifespan of air within a specific space, and serves as an indicator representing freshness of air. The indicator enables assessment of a ventilation degree and efficient HVAC operation. However, the MAA may not be directly measured through a specific sensor. In a tracer gas-based experimental method (e.g., ISO 16000-8), which is an MAA measurement method currently in use, a decay method is used to measure a time it takes for a labeled tracer gas to disappear. In order to use the method, a tracer gas such as carbon dioxide (CO₂) has to be continuously supplied indoors to evaluate the TAQ. Therefore, it is difficult to apply the method in an indoor space in which a resident is present.

Accordingly, in most existing researches, an MAA within a building is calculated by using computational fluid dynamics (CFD) to which user-defined scalar (UDS) transport is added. While CFD is an effective method, it takes a long time to calculate in large spaces, and requires significant calculation resources. In addition, when an internal structure is changed, new modeling, meshing, calculation, and analysis processes have to be performed again so that an additional time is required.

In order to solve the above problems, deep learning-based approaches have recently been attracting attention in order to rapidly estimate the MAA in real time even when a building structure is changed. However, such researches mainly aim at monitoring IAQ of an entire building so as to be insufficient for managing an MAA of a specific space. Furthermore, the researches do not analyze how much factors such as HVAC operating conditions or inlet positions affect an MAA of a specific position so as to have limitations in efficiently managing an MAA of a region of interest. Therefore, development of a method for accurately predicting an MAA of a region of interest according to HVAC operating conditions and analysis of importance of a key factor affecting an MAA of a specific space are essential for implementing future HVAC systems.

Recently, machine learning models are being utilized in various application fields such as thermal management systems, virtual sensors, on-chip image classification, and air flow prediction. Such deep learning models may derive non-linear relation between input and output variables through an appropriate learning process. However, since most deep learning models are black-box models, it is difficult to clearly describe how results are derived.

In order to solve the above problem, explainable artificial intelligence (XAI), which is also referred to as a white-box model, has been developed so as to be applied to various deep learning models. When the XAI is applied to various deep learning models, it is possible to describe how the model derives results based on specific input variables. Permutation feature importance (PFI) is one of such XAI techniques. The PFI is widely used in various deep learning models such as regression or classification models, and the PFI is an effective method for visually demonstrating contribution of each input variable when an output result is derived. Therefore, an input variable that is meaningful for deriving a target result may be selected based on a contribution value calculated through the PFI.

### DOCUMENTS OF RELATED ART

### Patent Documents

(Patent Document 1) Korean Unexamined Patent Publication No. 10-2007-0083055 (published on Aug. 23, 2007)

### SUMMARY OF THE INVENTION

One object of the present invention is to provide a system for designing a position of a ventilation inlet by using an air age prediction model, capable of rapidly and accurately designing an optimal position of the ventilation inlet by utilizing computational fluid dynamics simulation and a machine learning-based air age prediction model.

Another object of the present invention is to provide a method for designing a position of a ventilation inlet by using an air age prediction model, capable of efficiently improving indoor air quality.

To achieve the one object of the present invention, a system for designing a position of a ventilation inlet by using an air age prediction model includes: a data input unit for inputting position information of a group of candidates for the ventilation inlet based on a position of a facility within a target space; and a ventilation inlet position determination unit for determining an installation position of the ventilation inlet by using information of the facility and the position information of the group of candidates for the ventilation inlet as input data, and outputting mean air age data at a periphery of the facility according to a variation in a flow velocity of air introduced into the ventilation inlet to the air age prediction model.

According to one embodiment, the system may further include: a training data construction unit for generating the mean air age data at the periphery of the facility as training data by applying boundary information of the target space and boundary information of the group of candidates for the ventilation inlet to computational fluid dynamics (CFD); and a prediction model determination unit for determining one of a plurality of machine learning models as the air age prediction model by individually training the training dataset through the machine learning models, and evaluating training performance.

According to one embodiment, the machine learning model may include multiple linear regression (MLR), K-nearest neighbor (KNN), and a deep neural network (DNN).

According to one embodiment, the prediction model determination unit may determine the air age prediction model by calculating a coefficient of determination (R²), a mean absolute error (MAE), and a mean squared error (MSE) for training performance of each of the machine learning models, and using the coefficient of determination (R²), the mean absolute error (MAE), and the mean squared error (MSE) as evaluation indicators.

According to one embodiment, the ventilation inlet position determination unit may determine the installation position of the ventilation inlet according to contribution to the mean air age data among the group of candidates for the ventilation inlet by applying permutation feature importance (PFI) to the air age prediction model.

According to one embodiment, the target space may include a hospital room, the facility may include a patient bed, and the information of the facility may include position information, width information, and height information of the patient bed.

To achieve the another object of the present invention, a method for designing a position of a ventilation inlet by using an air age prediction model includes: a data input step of inputting position information of a group of candidates for the ventilation inlet based on a position of a facility within a target space; and a ventilation inlet position determination step of determining an installation position of the ventilation inlet by using information of the facility and the position information of the group of candidates for the ventilation inlet as input data, and outputting mean air age data at a periphery of the facility according to a variation in a flow velocity of air introduced into the ventilation inlet to the air age prediction model.

According to one embodiment, the method may further include: a training data construction step of generating the mean air age data at the periphery of the facility as training data by applying boundary information of the target space and boundary information of the group of candidates for the ventilation inlet to computational fluid dynamics (CFD); and a prediction model determination step of determining one of a plurality of machine learning models as the air age prediction model by individually training the training dataset through the machine learning models, and evaluating training performance.

According to one embodiment, the machine learning model may include multiple linear regression (MLR), K-nearest neighbor (KNN), and a deep neural network (DNN).

According to one embodiment, in the prediction model determination step, the air age prediction model may be determined by calculating a coefficient of determination (R²), a mean absolute error (MAE), and a mean squared error (MSE) for training performance of each of the machine learning models, and using the coefficient of determination (R²), the mean absolute error (MAE), and the mean squared error (MSE) as evaluation indicators.

According to one embodiment, in the ventilation inlet position determination step, the installation position of the ventilation inlet may be determined according to contribution to the mean air age data among the group of candidates for the ventilation inlet by applying permutation feature importance (PFI) to the air age prediction model.

According to one embodiment, the target space may include a hospital room, the facility may include a patient bed, and the information of the facility may include position information, width information, and height information of the patient bed.

According to the present invention, CFD simulation and a machine learning-based air age prediction model can be utilized to rapidly and accurately predict distribution of a mean age of air according to various spatial conditions and ventilation variables so that an optimal position of a ventilation inlet can be automatically designed, and thus ventilation performance can be maximized.

In addition, according to the present invention, an indoor air flow can be quantitatively analyzed based on an air age prediction model to derive a position of a ventilation inlet, which allows a mean age of air to be reduced with minimal energy, so that indoor air quality (IAQ) can be effectively improve while energy efficiency is increased.

### BRIEF DESCRIPTION OF THE DRAWINGS

FIG. 1 is a view for describing a system for designing a position of a ventilation inlet by using an air age prediction model according to the present invention.

FIG. 2 is a view for describing a method for designing a position of a ventilation inlet by using an air age prediction model according to the present invention.

FIG. 3 is a view showing a workflow of the system for designing the position of the ventilation inlet by using the air age prediction model according to the present invention according to an embodiment of the present invention.

FIGS. 4A to 4D are views showing distribution of a mean age of air (MAA) for constructing a dataset and geometric modeling for computational fluid dynamics according to an embodiment of the present invention. FIGS. 4A and 4B are isometric and plan views showing a hospital ward with an indoor double room, and FIGS. 4C and 4D are sectional views of FIG. 4B taken along a-a′ and b-b′, respectively.

FIG. 5 is a view showing data set distribution of (a) a raw dataset and (b) a log-scale dataset for MAA₁, and (c) a raw dataset and (d) a log-scale dataset for MAA₂ according to an embodiment of the present invention.

FIG. 6 is a view showing an example of a DNN regression model architecture having four types of layers for prediction of mean age of air (MAA₁ and MAA₂) according to an embodiment of the present invention.

FIG. 7 is a view obtained by visualizing variations in a training loss and a validation loss of three DNN regression models (DNN-1, DNN-2, and DNN-3) according to the number of epochs according to an embodiment of the present invention.

FIG. 8 is a view showing a result of comparing performance of regression models (MLR, KNN, and a DNN) for predicting mean age of air (MAA₁ and MAA₂) according to an embodiment of the present invention.

FIGS. 9A to 9C are views obtained by visualizing distribution of results of predicting mean age of air (MAA₁ and MAA₂) by applying regression models (MLR, KNN, and a DNN) based on the same dataset according to an embodiment of the present invention.

FIG. 10 is a view showing an importance score of an input variable (a flow velocity for each ventilation inlet position), which is derived by applying permutation feature importance to a DNN-based air age prediction model, to prediction of mean age of air (MAA₁ and MAA₂) according to an embodiment of the present invention.

FIG. 11 is a view showing a result of selecting top and bottom variables that have the most influence on each of mean age of air (MAA₁ and MAA₂) by applying permutation feature importance to a DNN-based air age prediction model, and performing the DNN-based air age prediction model again by using only the variables as input values according to an embodiment of the present invention.

FIGS. 12A to 12H are views showing prediction results of mean age of air (MAA₁ and MAA₂) according to each inlet velocity variation for a combination of major input variables derived by applying permutation feature importance to an air age prediction model according to an embodiment of the present invention.

FIG. 13 is a view showing comparison of variations in mean age of air (MAA₁ and MAA₂) according to an increase in an introduction velocity for various ventilation inlet combinations based on black dotted lines (an identical introduction velocity condition) indicated in (b) of each of FIGS. 12A to 12H according to an embodiment of the present invention.

### DETAILED DESCRIPTION OF THE INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

As used herein, a “ventilation inlet” may refer to an inlet for supplying air into a target space. The ventilation inlet may correspond to a starting point of air circulation that induces a flow of air within the target space.

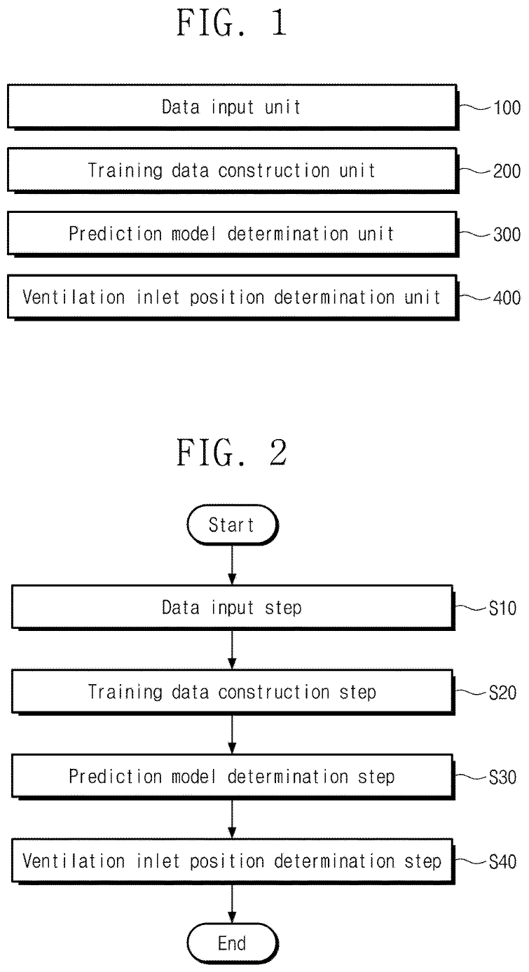

FIG. 1 is a view for describing a system for designing a position of a ventilation inlet by using an air age prediction model according to the present invention.

Referring to FIG. 1, a system for designing a position of a ventilation inlet by using an air age prediction model according to the present invention may include a data input unit 100, a training data construction unit 200, a prediction model determination unit 300, and a ventilation inlet position determination unit 400.

The data input unit 100 may input position information of a group of candidates for the ventilation inlet based on information of a facility within a target space. The position information of the group of candidates for the ventilation inlet may be a position of the ventilation inlet for identifying a region in which an air flow is slowed down or stagnated due to the facility so as to cause the air to remain for a long time, and allowing the air flow to be smooth in the region, and may be set considering feasibility of installation.

The target space may refer to any space that may directly affect indoor comfortableness, productivity, and health of a resident depending on ventilation performance. For example, the target space may be a residential space, a medical space, or an indoor workspace in which a person stays for a long period. In detail, the target space may be a space such as a home, an intensive care unit, a general hospital ward, an isolation hospital room, an office, a lecture hall, a conference room, or a laboratory.

The facility may refer to a structure disposed within the target space and capable of affecting the air flow and the ventilation performance. The presence or absence and arrangement of the facility may affect distribution of a mean age of air within the target space. According to the present invention, the facility may correspond to an important variable in determining an optimal position of the ventilation inlet. In addition, when a position or activity of a person affects the air flow, the person may be considered as a facility and reflected accordingly.

The information of the facility may include position information, length information, width information, height information, and shape information of the facility, and the like. In addition, the information of the facility may further include surface characteristic information such as material quality, thermal conductivity, and surface roughness of a surface of the facility.

According to an embodiment, the target space may include a hospital room, the facility may include a patient bed, and the information of the facility may include position information, width information, and height information of the patient bed.

The training data construction unit 200 may generate mean air age data at a periphery of the facility as training data by applying boundary information of the target space and boundary information of the group of candidates for the ventilation inlet to computational fluid dynamics (CFD).

According to an embodiment, the training data construction unit 200 may perform geometric modeling and grid generation (meshing) based on the boundary information of the target space and the boundary information of the group of candidates for the ventilation inlet, and apply the geometric modeling and the grid generation to the computational fluid dynamics. Simulation may be performed for each air flow condition and ventilation scenario through the computational fluid dynamics, and the mean air age data at the periphery of the facility may be extracted from a result of the simulation so as to be generated as the training data.

The boundary information of the target space may include position, size, shape, and structural characteristic information on a boundary surface that physically separates the target space, such as a wall body, a ceiling, or a floor. In detail, the boundary information of the target space may include a height of the ceiling, a thickness and arrangement of the wall body, a position and a size of a door and a window, presence or absence of a step difference of a floor, and the like, and may also include geometric shape information such as a straight-line or curved-surface shape at an outer edge of the space.

The boundary information of the group of candidates for the ventilation inlet may include position information, shape information, and size information of the group of candidates for the ventilation inlet, and the like. For example, the boundary information of the group of candidates for the ventilation inlet may include a position, a width, a height, and a sectional shape (e.g., circular, rectangular, etc.) of the inlet and the like.

The geometric modeling may be performed based on the boundary information of the target space and the boundary information of the group of candidates for the ventilation inlet. The geometric modeling may be constructed as a three-dimensional model.

The grid generation may be performed based on the geometric model. The grid generation may be configured such that the target space may be subdivided into a plurality of cells or grid elements. In general, the grid may have a hexahedral structure. However, embodiments are not limited thereto. According to an embodiment, the grid generation may be performed by using an ANSYS meshing tool.

The computational fluid dynamics may be a technology for mathematically modeling a physical behavior of a fluid, and numerically analyzing a flow of the fluid by using a computer, in which flow analysis for various ventilation conditions may be performed based on geometric modeling and grid generation contents that reflect the boundary information of the target space and the boundary information of the group of candidates for the ventilation inlet.

According to an embodiment, the computational fluid dynamics may be based on a mathematical governing equation representing a behavior of a fluid, and may be performed by numerically analyzing equations corresponding to Formula 1 to Formula 5.

$$\begin{matrix}[ Formula 1 ] & \\ \frac{\partial ρ}{\partial t} + ∇ \cdot ( ρ \vec{v} ) = 0 & ( 1 )\end{matrix}$$

$$\begin{matrix}[ Formula 2 ] & \\ \frac{\partial ρ \vec{v}}{\partial t} + ∇ \cdot ( ρ \vec{v} \vec{v} ) = - ∇ p + ∇ \cdot ( \vec{τ} ) + ρ \vec{g} & ( 2 )\end{matrix}$$

In Formula 1 and Formula 2, t may represent a time(s), p may represent density of a fluid (kg/m³), \vec{v} may represent air velocity (m/s), p may represent pressure (N/m²), \vec{τ} may represent a stress tensor, and ρ\vec{g} may represent a gravitational body force.

Formula 1 may be a mass conservation equation, and Formula 2 may be a momentum conservation equation. In order to ensure numerical stability of pressure-velocity computation in Formula 1 and Formula 2, a coupled algorithm may be used for discretization of pressure-velocity coupling. In addition, in Formula 2, spatial discretization may be performed by applying a second-order upwind scheme. A turbulence model (realizable k-ε turbulence model) may be applied in order to reflect characteristics of a turbulent flow.

In this case, an auxiliary equation for calculating turbulent kinetic energy (k) and a turbulent dissipation rate (¿) may be numerically analyzed by using a first-order upwind scheme. The auxiliary equation may be a model required for calculating a turbulent stress term of Formula 2, which is the momentum conservation equation, and may contribute to stable simulation of an entire flow field.

Meanwhile, in order to analyze distribution of a mean age of air, additional transport equations including a user-defined scalar (UDS) may be expressed as Formula 3 to Formula 5. The Formula 3 to Formula 5 may be numerically solved in the form including advection and diffusion terms, and may provide a mathematical basis for calculating the mean age of air.

$$\begin{matrix}[ Formula 3 ] & \\ \frac{\partial ρ {Φ}_{i}}{\partial t} + ∇ \cdot ( ρ \vec{v} {Φ}_{i} ) - ∇ \cdot ( {Γ}_{i} ∇ {Φ}_{i} ) = {S}_{{Φ}_{i}} & ( 3 )\end{matrix}$$

Formula 3 may be simplified into the form as Formula 4 below under a steady-state condition.

$$\begin{matrix}[ Formula 4 ] & \\ ∇ . ( ρ {Φ}_{i} - {Γ}_{i} ∇ {Φ}_{i} ) = {S}_{{Φ}_{i}} & ( 4 )\end{matrix}$$

$$\begin{matrix}[ Formula 5 ] & \\ {Γ}_{i} = 2.88 \times 1 {0}^{- 5} ρ + \frac{{μ}_{e f f}}{0.7} & ( 5 )\end{matrix}$$

In the Formula 3 to Formula 5, \vec{v} may be a fluid velocity (m/s), ρ may be fluid density, Φᵢ may be a mean air age scalar to be calculated, Γᵢ may be a diffusion coefficient, μ_{eff} may be effective viscosity of air (kg/m·s), and S_{Φ}_{ᵢ} may be a source term of the mean air age scalar.

The prediction model determination unit 300 may determine one of a plurality of machine learning models as the air age prediction model by individually training the training dataset through the machine learning models, and evaluating training performance. The machine learning models may exhibit different prediction performance depending on a type of problem to be solved. Therefore, the prediction model determination unit 300 may compare accuracy of each approach by using the machine learning models, and finally determine the air age prediction model from one of the machine learning models.

According to an embodiment, the training dataset may be a preprocessed training dataset. The preprocessing may mitigate skewness of the training dataset, and ensure stability of model training. The preprocessing may be performed by applying natural logarithmic scaling.

The training dataset may include training dataset, validation dataset, and test dataset.

The training dataset may be data used to compare performance of air age prediction models and determine the model. The training data may include an input variable and a mean age of air (MAA) value corresponding thereto, and may be used for machine learning models to be trained with functional relation between input and output.

The validation data may be data used to compare and evaluate generalization performance of the machine learning models or adjust a hyperparameter. The validation data may not be used for actual training, and may contribute to inspection of overfitting of the model and selection of an optimal model.

The test dataset may be data used to objectively evaluate predictive performance of the air age prediction models, and may include independent data that has not been used for training or validation.

According to an embodiment, the training dataset may be divided into the training dataset, the validation dataset, and the test dataset after the skewness is mitigated through the natural logarithmic scaling, and min-max normalization (min-max scaling) based on minimum and maximum values calculated based on the training data may be applied equally to each dataset. The min-max normalization may be represented as Formula 6 below.

$$\begin{matrix}[ Formula 6 ] & \\ {X}_{s c a l e d} = \frac{{x}_{i} - {x}_{min ( i )}}{{x}_{max ( i )} - {x}_{min ( i )}} ( i = 1 , 2 , 3 , 4 ) & ( 6 )\end{matrix}$$

In Formula 6, X_{scaled}, xₘᵢₙ₍ᵢ₎, and xₘₐₓ₍ᵢ₎ may represent a scaled value, a minimum value, and a maximum value of xᵢ for a ward i, respectively.

The machine learning model may include multiple linear regression (MLR), K-nearest neighbor (KNN), and a deep neural network (DNN).

The MLR may be a regression technique for mathematically modeling linear relation between an independent variable and a dependent variable. The MLR may configure a fitted plane based on the relation between the independent variable (xₘ) and the dependent variable (yₙ), which may be expressed as Formula 7 below.

$$\begin{matrix}[ Formula 7 ] & \\ {y}_{n} = {β}_{n 0} + {β}_{n 1 x 1} + {β}_{n 2 x 2} … + {β}_{n m x m} & ( 7 )\end{matrix}$$

In Formula 7, βₙₘ may represent a coefficient for each input variable.

The KNN may be a supervised learning algorithm, and may be a data-based machine learning model capable of performing both classification and regression by applying a nonparametric technique. The KNN may calculate a distance between the test dataset and the training data, select a k-nearest training data pointer, and calculate an average of output values of the k-nearest training data pointer as a prediction result. The KNN may be effective for non-linear data distribution, and may perform prediction based on actual data distributions without modeling.

According to an embodiment, five neighbors have been selected in prediction of a mean age of air using the KNN, and calculation of a distance between the neighbors has been evaluated based on a Euclidean distance (D) as follows. The Euclidean distance (D) may be expressed as Formula 8 below.

$$\begin{matrix}[ Formula 8 ] & \\ D = \sqrt{{\sum }_{i = 1}^{N} {( {X}_{i} - {y}_{i} )}^{2}} & ( 8 )\end{matrix}$$

In Formula 8, N may represent the number of features, Xᵢ may represent the number of test points, and Yᵢ may represent the number of training points.

The DNN may be a regression analysis technique utilizing a deep architecture of an artificial neural network, and may include an input layer, an output layer, and a plurality of hidden layers located between the input layer and the output layer. As the number of hidden layers increases, more complex features may be trained. The input layer, the output layer, and the hidden layer may be configured as fully connected layers. The input layer, the output layer, and the hidden layer may include artificial neurons that generate an output value y for an input value xᵢ, which may be expressed as Formula 9 below.

$$\begin{matrix}[ Formula 9 ] & \\ y = f ( b + \sum {w}_{i} {x}_{i} ) & ( 9 )\end{matrix}$$

In Formula 9, wᵢ, b, and f may represent a weight, bias, and an activation function, respectively.

The activation function may enable training of a complex pattern by imparting non-linearity to an output of the artificial neuron. An output value generated by a non-linear activation function may be transmitted to a neuron of a next layer so as to be used as a new input value. Through such an iterative structure, non-linear relation between an initial input and a final output may be effectively trained.

According to an embodiment, a non-linear activation function such as a rectified linear unit (ReLU) may be used in the hidden layer, and a linear activation function may be used in the output layer.

In order to quantitatively evaluate training performance of each of the machine learning models, the prediction model determination unit 300 may determine the air age prediction model by calculating a mean absolute error (MAE), a mean squared error (MSE), and a coefficient of determination (R-squared, R²), and using the mean absolute error (MAE), the mean squared error (MSE), and the coefficient of determination (R-squared, R²) as evaluation indicators.

The mean absolute error (MAE), the mean squared error (MSE), and the coefficient of determination (R²) may be expressed as Formula 10 to Formula 12 below, respectively.

$$\begin{matrix}[ Formula 10 ] & \\ MAE = \frac{1}{n} {\sum }_{i = 1}^{n} \vert {y}_{i} - {p}_{i} \vert & ( 10 )\end{matrix}$$

$$\begin{matrix}[ Formula 11 ] & \\ MSE = \frac{1}{n} {\sum }_{i = 1}^{n} {( {y}_{i} - {p}_{i} )}^{2} & ( 11 )\end{matrix}$$

$$\begin{matrix}[ Formula 12 ] & \\ R - squared = 1 - \frac{{\sum }_{i = 1}^{n} {( {y}_{i} - {p}_{i} )}^{2}}{{\sum }_{i = 1}^{n} {( {y}_{i} - \overline{y} )}^{2}} & ( 12 )\end{matrix}$$

In Formula 10 to Formula 12, n may represent the number of data points, and y may represent an average value.

The mean absolute error (MAE) may be a value obtained by calculating absolute values of errors between a prediction value and an actual value and averaging the absolute values, and may be an indicator that enables intuitive recognition of a size of the error. According to an embodiment, the MAE may be a value obtained by averaging absolute differences between a predicted mean air age value and an actual mean air age value, and may quantitatively represent a size of an average prediction error.

The mean squared error (MSE) may be a value obtained by squaring the errors between the prediction value and the actual value and averaging the errors, and may be an indicator that enables evaluation of sensitivity to a large error. As a value of the MSE decreases, prediction performance may gradually become superior.

The coefficient of determination (R²) may be an indicator representing how well the prediction value describes variability (variance) of the actual value. The R² may generally have a value between 0 and 1, and as the R² becomes closer to 1, the prediction performance may gradually become superior. However, since an overfitted model has a high R² value only for the training data, and the prediction performance may rapidly decrease in an actual environment, there may be limitations in evaluating the performance of the model only with an R² value so that it may be desirable to review the R² together with other indicators such as the MAE and the MSE.

The air age prediction model may be a regression-based machine learning model for predicting a mean age of air at a specific position within the target space, and may refer to a final machine learning model determined by the prediction model determination unit 300.

According to an embodiment, a DNN-based model may be used as the air age prediction model.

The ventilation inlet position determination unit 400 may determine an installation position of the ventilation inlet by using information of the facility and the position information of the group of candidates for the ventilation inlet as input data, and outputting mean air age data at a periphery of the facility according to a variation in a flow velocity of air introduced into the ventilation inlet to the air age prediction model.

The ventilation inlet position determination unit 400 may determine the installation position of the ventilation inlet according to contribution to the mean air age data among the group of candidates for the ventilation inlet by applying permutation feature importance to the air age prediction model.

The permutation feature importance may be a widely used approach for identifying an influence of each input variable on prediction, may be a method for quantitatively evaluating an influence of an input variable on an output value of the air age prediction model by observing a variation in prediction performance while a value of the input variable is randomly changed, and may be a universal variable importance evaluation technique that is applicable to all machine learning models. As the prediction performance decreases significantly, the variable may be considered to have a greater influence on an output of the air age prediction model so that a variable that is relatively more important (i.e., a variable that has a greater influence on air age prediction) may be selected.

According to an embodiment, the permutation feature importance may be calculated by performing random permutations of input variables 20 times based on the test dataset by utilizing a permutation importance library of Scikit-learn.

The contribution to the mean air age data may be a value obtained by quantitatively evaluating how much a flow velocity value of each ventilation inlet position among the input variables of the air age prediction model affects the predicted mean air age value.

FIG. 2 is a view showing a method for designing a position of a ventilation inlet by using an air age prediction model according to the present invention.

Referring to FIG. 2, a method for designing a position of a ventilation inlet by using an air age prediction model according to the present invention may include a data input step S10, a training data construction step S20, a prediction model determination step S30, and a ventilation inlet position determination step S40.

In the data input step S10, position information of a group of candidates for the ventilation inlet may be input based on a position of a facility within a target space.

According to an embodiment, the target space may include a hospital room, the facility may include a patient bed, and the information of the facility may include position information, width information, and height information of the patient bed.

In the training data construction step S20, the mean air age data at the periphery of the facility may be generated as training data by applying boundary information of the target space and boundary information of the group of candidates for the ventilation inlet to computational fluid dynamics (CFD).

The boundary information of the target space may include position, size, shape, and structural characteristic information on a boundary surface that physically separates the target space, such as a wall body, a ceiling, or a floor. In detail, the boundary information of the target space may include a height of the ceiling, a thickness and arrangement of the wall body, a position and a size of a door and a window, presence or absence of a step difference of a floor, and the like, and may also include geometric shape information such as a straight-line or curved-surface shape at an outer edge of the space.

The boundary information of the group of candidates for the inlet may include position information, shape information, and size information of the group of candidates for the inlet, and the like. For example, the boundary information of the group of candidates for the inlet may include a position, a width, a height, and a sectional shape (e.g., circular, rectangular, etc.) of the inlet and the like.

The computational fluid dynamics may refer to prediction of a fluid behavior based on a fluid dynamics theory through a computer. Flow analysis for various ventilation conditions may be performed based on geometric modeling and grid generation contents that reflect the boundary information of the target space and the boundary information of the group of candidates for the ventilation inlet.

According to an embodiment, the computational fluid dynamics may be based on a mathematical governing equation representing a behavior of a fluid, and may be performed by numerically analyzing equations corresponding to Formula 1 to Formula 5.

In the prediction model determination step S30, one of a plurality of machine learning models may be determined as the air age prediction model by individually training the training dataset through the machine learning models, and evaluating training performance.

The training dataset may be a training dataset on which a preprocessing step has been performed. The preprocessing step may mitigate skewness of the data, thereby contributing to improving stability of model training and prediction accuracy. According to an embodiment, in the preprocessing step, natural logarithmic scaling may be performed.

The machine learning model may include multiple linear regression (MLR), K-nearest neighbor (KNN), and a deep neural network (DNN).

In the prediction model determination step S30, in order to quantitatively evaluate training performance of each of the machine learning models, the air age prediction model may be determined by calculating a mean absolute error (MAE), a mean squared error (MSE), and a coefficient of determination (R-squared, R²), and using the mean absolute error (MAE), the mean squared error (MSE), and the coefficient of determination (R-squared, R²) as evaluation indicators.

The air age prediction model may be a regression-based machine learning model for predicting a mean age of air at a specific position within the target space, and may refer to a final machine learning model determined by the prediction model determination step S30.

According to an embodiment, a DNN-based model may be used as the air age prediction model.

In the ventilation inlet position determination step S40, the installation position of the ventilation inlet may be determined according to contribution to the mean air age data among the group of candidates for the ventilation inlet by applying permutation feature importance (PFI) to the air age prediction model.

According to an embodiment, the permutation feature importance may be calculated by performing random permutations of input variables 20 times based on the test dataset by utilizing a permutation importance library of Scikit-learn.

The contribution to the mean air age data may be a value obtained by quantitatively evaluating how much a flow velocity value of each ventilation inlet position among the input variables of the air age prediction model affects the predicted mean air age value.

### Example

### Overview of Example

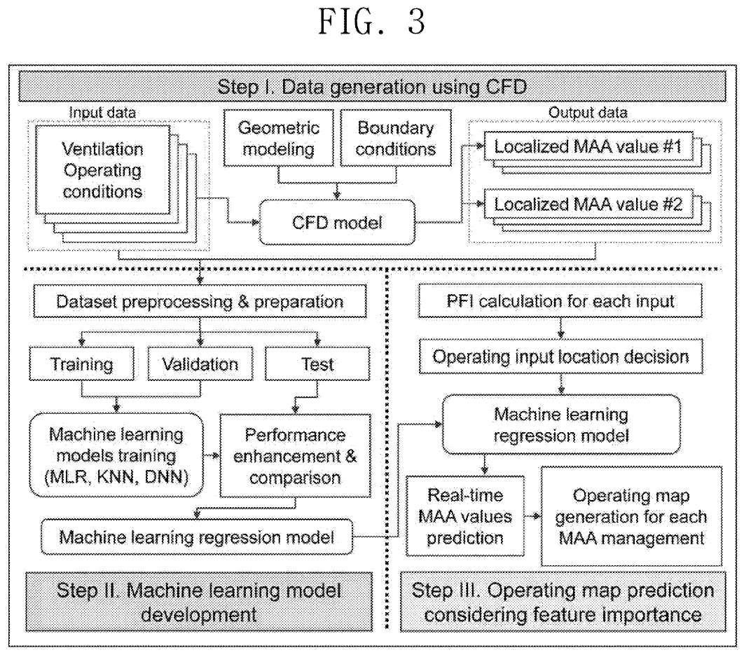

FIG. 3 is a view showing a workflow of the system for designing the position of the ventilation inlet by using the air age prediction model according to the present invention according to an embodiment of the present invention.

Referring to FIG. 3, the system for designing the position of the ventilation inlet by using the air age prediction model according to an embodiment of the present invention roughly includes three steps. A first step (Step I) is dataset construction using computational fluid dynamics, a second step (Step II) is training and optimization of a machine learning model, and a third step (Step III) is generation of an operating map considering importance of each input variable.

Since a mean age of air is a parameter that may not be directly measured in the first step, computational fluid dynamics was performed by applying geometric modeling for boundary conditions of a target indoor space and a ventilation system. Dataset was constructed by calculating values of the mean age of air at specific positions under various ventilation conditions. Thereafter, preprocessed dataset was divided into training dataset, validation dataset, and test dataset so as to be used to train and validate a model in the second step.

In the second step, machine learning regression models of MLR, KNN, and a DNN were trained and compared in this process to develop a virtual sensing model capable of accurately deriving the value of the mean age of air, that is, an air age prediction model.

In the third step, PFI was utilized to search for a key input condition for achieving a target mean age of air. As a result, a method capable of effectively managing the mean age of air while reducing the number of input conditions was derived, which enabled generation of a prediction-based operating map as well as real-time prediction of a mean age of air.

### Data Input

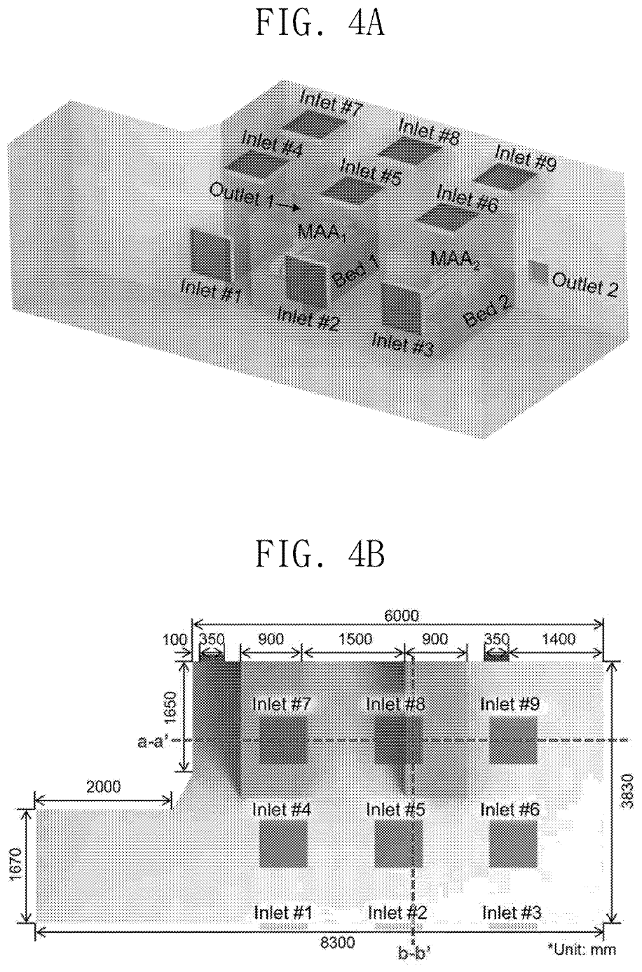

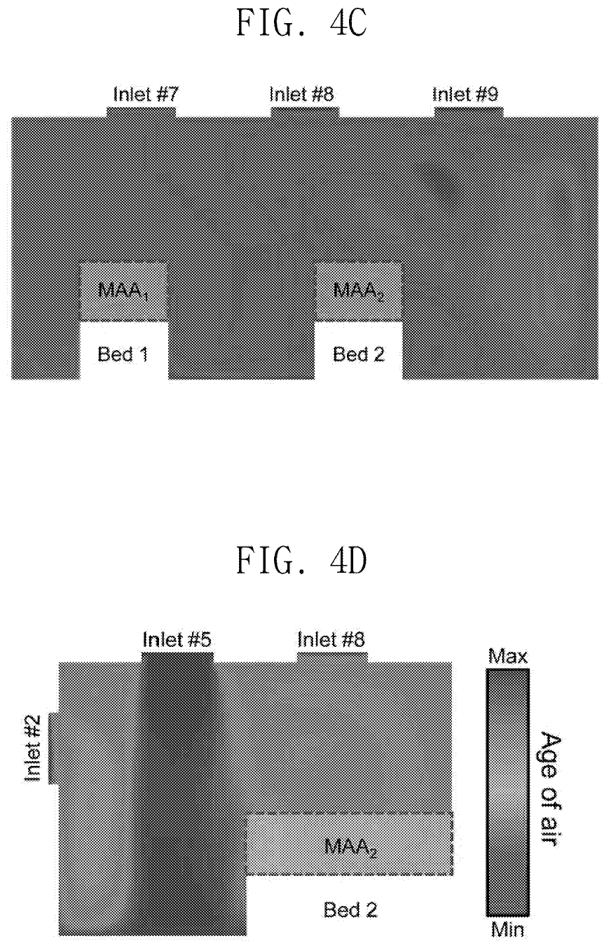

FIG. 4A to 4D are views showing distribution of a mean age of air (MAA) for constructing a dataset and geometric modeling for computational fluid dynamics according to an embodiment of the present invention. FIGS. 4A and 4B are isometric and plan views showing a hospital ward with an indoor double room, and FIGS. 4C and 4D are sectional views of FIG. 4B taken along a-a′ and b-b′, respectively.

Referring to FIGS. 4A and 4B, a hospital was set as an example of a system for designing a position of a ventilation inlet by using an air age prediction model according to the present invention. A target space is a hospital room, and facilities are a bed 1 Bed 1 and a bed 2 Bed 2. FIGS. 4A and 4B show results of geometric modeling for the hospital room space, in which positions of nine ventilation inlets Inlet #1 to #9 and two outlets Outlet #1 and #2 disposed inside the hospital room are visualized.

In particular, referring to FIG. 4B, which is a plan view showing a three-dimensional spatial configuration of FIG. 4A, relative positions and dimensional units (mm) of respective inlets, beds, wall bodies, and the like are presented. A width and a height of a bed, a height of a hospital room, sizes of an inlet and an outlet, and the like were set according to values specified in Table 1 below, which is a result of simulating an actual hospital ward environment.

TABLE 1

| Geometry | Dimension [mm] |
|---|---|
| Inlet width and height | 700 |
| Outlet width and height | 350 |
| Bed width | 2000 |
| Bed height | 600 |
| Hospital ward height | 2700 |

A hexahedral mesh was generated by using ANSYS meshing for the geometric model, and a solution grid was divided with setting values, which are orthogonal quality of 0.26 and maximum skewness of 0.83.

In a grid dependency test, mean age of airs MAA₁ and MAA₂ stably converged after a grid number of 301, 343. Therefore, in order to ensure high reliability while reducing a calculation time, all calculations for obtaining dataset were performed at the grid number of 301, 343.

Referring to FIGS. 4C and 4D, which are views visually presenting CFD analysis results for the mean age of air, distribution of an age of air within a space is expressed in a unit of a section based on a-a′ and b-b′ sections shown in FIG. 4B.

Referring to FIG. 4C, distribution of the mean age of air on the a-a′ section is shown, in which MAA₁ and MAA₂ measurement positions that are set above the bed 1 and the bed 2, respectively, are indicated by dotted line boxes. Referring to FIG. 4D, the view shows a result on the b-b′ section, which shows how MAAü is distributed within a flow path including Inlets #2, #5, and #8. In this case, as introduction conditions, a flow velocity of Inlet #3 was set to 1 m/s, and a flow velocity of Inlet #5 was set to 3 m/s, while the remaining inlets were configured to be inactive.

Referring again to FIGS. 4C and 4D together, as shown in computational fluid dynamics results, a bluish color refers to a region with a low age of air, a reddish color refers to a region with a high age of air, and efficiency of a ventilation flow and an air stagnation zone may be visually identified. Accordingly, an influence of characteristics of an air flow at a periphery of a bed and a combination of inlets on a value of a mean age of air may be intuitively understood.

### Construction of Training Data

In order to prepare training data, as shown in FIG. 4A, flow velocities of the nine inlets and mean age of air at specific positions (i.e., spaces above the bed 1 Bed 1 and the bed 2 Bed 2) were considered for parametric researches. In particular, the mean age of air at the specific positions were set considering a situation in which patients are lying in the beds in the hospital ward. In addition, in order to consider energy efficiency and practical applicability of HVAC, the training dataset was obtained by restricting operations of the nine inlets so that a minimum of one inlet to a maximum of three inlets are operated among the nine inlets. The fluid velocities of the operated inlets were randomly set within a range of 1 to 5 m/s. Computational simulation was used to obtain MAA₁ and MAA₂ values for the space above the bed 1 and the bed 2 through 5488 different cases under various HVAC operating conditions.

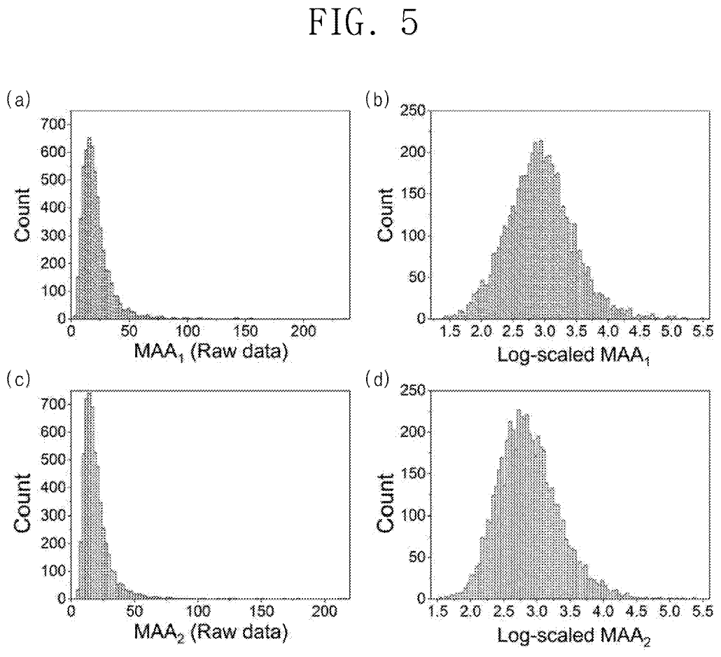

FIG. 5 is a view showing data set distribution of (a) a raw dataset and (b) a log-scale dataset for MAA₁, and (c) a raw dataset and (d) a log-scale dataset for MAA₂ according to an embodiment of the present invention.

Referring to (a) and (c) of FIG. 5, raw data of MAA₁ and exhibited skewed distribution. This occurs because MAA MAA₂ significantly increases as the number of ventilation devices and a flow rate decrease.

Therefore, referring to (b) and (d) of FIG. 5, it may be found that skewness is mitigated by applying data scaling using an entire dataset natural logarithm for effective regression model training. As a result, absolute skewness values of MAA₁ and MAA₂ decreased to ~0.27 and ~0.11, respectively. In particular, in a case of MAA₁, a parameter decreased by ~84.3% (about 0.70→0.11 on a logarithmic scale).

After the log scaling step, a min-max scaling method was applied.

### Determination of Prediction Model

In order to execute MLR, KNN, and DNN algorithms on the dataset derived according to the example, Google Colaboratory Pro, which is a Python-based cloud computing platform using an Intel Xeon 2.20 GHZ CPU and a Tesla T4 GPU, was utilized. In addition, open source libraries such as Scikit-learn, Tensorflow, and Keras were used for subsequent model training. The dataset was randomly divided in a ratio of training:validation:test=7:1.5:1.5 (3841, 823, and 824 pieces, respectively). In addition, an early stopping technology was applied during DNN model training to improve prediction accuracy and prevent overfitting.

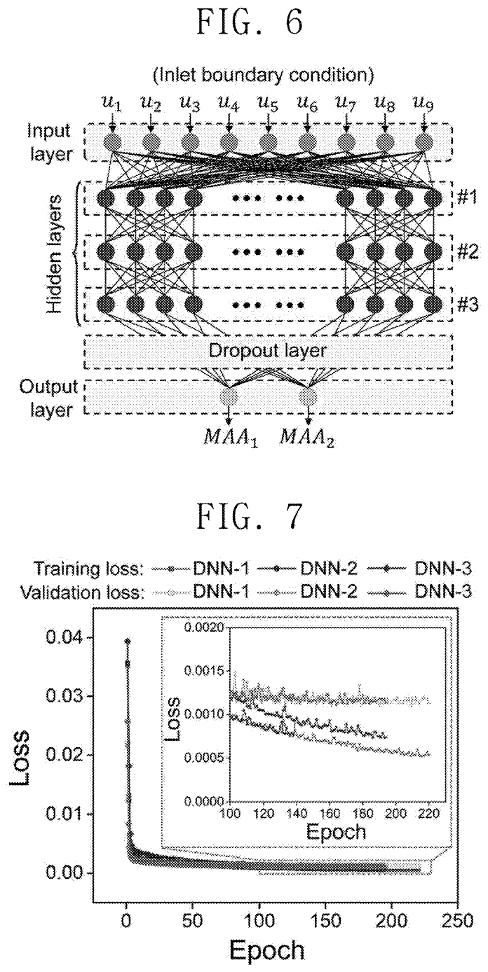

FIG. 6 is a view showing an example of a DNN regression model architecture having four types of layers for prediction of mean age of air (MAA₁ and MAA₂) according to an embodiment of the present invention.

Referring to FIG. 6, the DNN regression model architecture includes an input layer, a plurality of hidden layers, a dropout layer, and an output layer.

The input layer includes a total of nine nodes, which use flow velocities u₁ to u₉ measured at nine ventilation inlet positions as input variables, respectively.

A total of three hidden layers are provided, and nodes of respective hidden layers are fully connected to the input layer. A rectified linear unit (ReLU) is applied to each of the hidden layers to effectively model non-linear relation between the input variable and the mean age of air.

The dropout layer is located after the hidden layer, and used to prevent the overfitting. According to the example, a dropout rate of the dropout layer is set to 0.5.

The output layer includes two nodes, which predict the mean age of air MAA₁ and MAA₂ of two positions (above the bed 1 and above the bed 2) within the hospital room. A linear activation function is applied to the output layer so as to be set to derive continuous regression values.

In terms of a training method, the DNN model is iteratively trained over a plurality of epochs. In each epoch, an error and a loss function (e.g., MSE) between a prediction value and an actual value are calculated, and a weight and bias are updated though a backpropagation algorithm based on the error and the loss function. Through the above process, the model is gradually optimized, and prediction accuracy of the age of air is improved.

In addition, a Bayesian optimization technique was utilized to optimize a hyperparameter. The number of nodes of the hidden layer (ranging from 64 to 1024) and a training rate (0.01, 0.001, and 0.0001) were considered as an optimization target parameter.

The Bayesian optimization is based on randomly shuffled dataset, and enhances search efficiency by using an acquisition function and a Gaussian process. The above method may derive an optimal parameter more efficiently than existing grid search or random search.

TABLE 2

| | | DNN-1 | DNN-2 | DNN-3 |
|---|---|---|---|---|
| Number of nodes | Hidden layer | 704 | 896 | 1024 |
| | #1 | | | |
| | Hidden layer | 448 | 960 | 1024 |
| | #2 | | | |
| | Hidden layer | 960 | 1024 | 1024 |
| | #3 | | | |

| | | | |
|---|---|---|---|
| Training rate | 0.001 | 0.001 | 0.001 |

The three DNN models (DNN-1, DNN-2, and DNN-3) were configured by selecting an optimal structure based on a combination of hyperparameters listed in Table 2, and the three DNN models were trained by utilizing different training dataset and different validation dataset.

FIG. 7 is a view obtained by visualizing variations in a training loss and a validation loss of three DNN regression models (DNN-1, DNN-2, and DNN-3) according to the number of epochs according to an embodiment of the present invention.

Referring to FIG. 7, a magnified region (indicated by a red dotted line) represents a training process in which the early stopping technology is applied. The training process is set such that training is automatically stopped when a validation loss is not improved even after 30 iterations. The above setting prevents overfitting and ensures efficient model training.

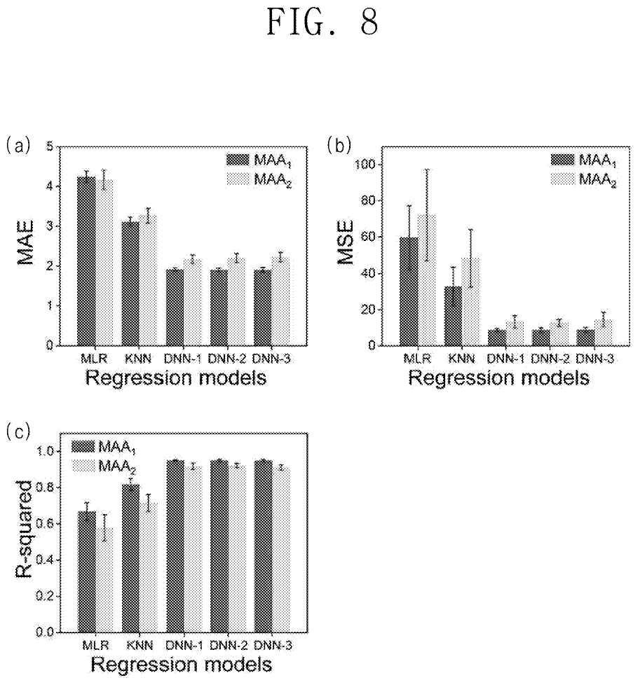

FIG. 8 is a view showing a result of comparing performance of regression models (MLR, KNN, and a DNN) for predicting mean age of air (MAA₁ and MAA₂) according to an embodiment of the present invention. FIGS. 8a, 8b, and 8c show a mean absolute error (MAE), a mean squared error (MSE), and a coefficient of determination (R²), respectively.

Referring to FIG. 8, prediction performance of the age of air MAA₁ and MAA₂ were compared by using three types of regression models, which are MLR, KNN, and a DNN, and evaluation was performed based on three regression indicators, which are (a) a mean absolute error (MAE), (b) a mean squared error (MSE), and (c) a coefficient of determination (R²). Through Formula 10 to Formula 12, values of the MAE, the MSE, and the R² were derived by using five randomly shuffled dataset.

Referring to (a) and (b) of FIG. 8, a DNN-based model exhibited lower MAE and MSE values than MLR and KNN models. Among the models, for MAA₁ prediction, a DNN-2 model exhibited an MAE decreased by 55.14% and 38.84% and an MSE also decreased by 85.42% and 73.47% as compared to MLR and KNN algorithms, respectively. In addition, for MAA₂ prediction, the DNN-2 model exhibited an MAE decreased by 47.20% and 32.70% on average and an MSE decreased by 82.45% and 73.88% as compared to the MLR and KNN models, respectively.

The DNN-2 model exhibited the best performance, and was selected as the air age model for subsequent analysis. In particular, for the MAA₁ prediction, the DNN-2 model exhibited MAE and MSE values of 1.90 and 8.70, respectively. In summary, the DNN model significantly reduced the MAE and MSE values as compared to other machine learning models in predicting the MAA value.

In particular, referring to (b) of FIG. 8, the MLR and KNN models exhibited larger error bars as well as high MSE values than the DNN model. This means that accuracy obtained through the MLR and the KNN easily fluctuates depending on the shuffled dataset, and large outliers occur more frequently in the prediction result.

In addition, referring to (c) of FIG. 8, average R² values of the DNN-2 model were 0.9506 and 0.9220 for the MAA₁ and MAA₂ predictions, respectively. Meanwhile, the MLR and KNN models exhibited average R² scores of less than 0.67 and 0.82, respectively, which indicates that the MLR and KNN models failed to accurately predict actual values.

Consequently, the MLR model failed to derive non-linear relation between an input boundary condition and an output MAA value. Although the performance of the KNN model was improved, accuracy (R²<0.82) was insufficient for the KNN model to be used as a surrogate model. Meanwhile, the DNN models effectively performed the MAA predictions even with various hyperparameter settings, and the DNN-2 model exhibited the best performance among the DNN models. Considering complexity of the MAA predictions, it is noteworthy that using the DNN model is more effective than using other models. Therefore, the DNN-2 model was subsequently utilized for PFI application.

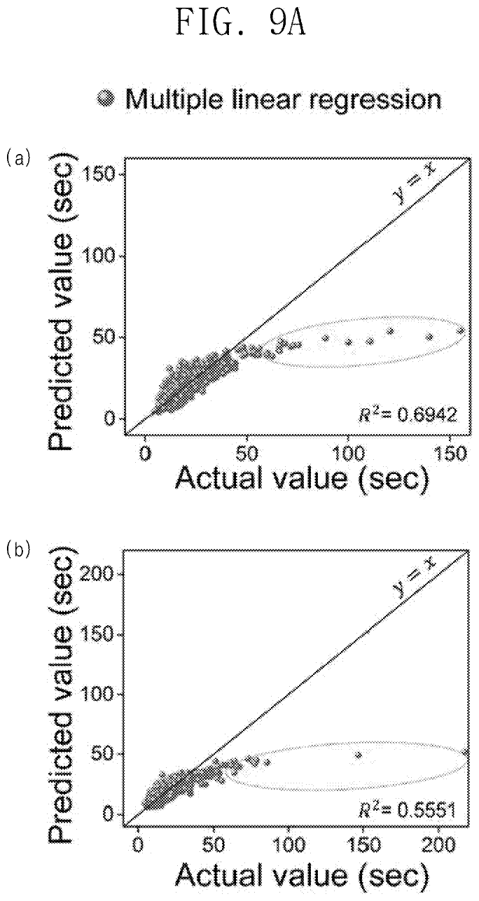

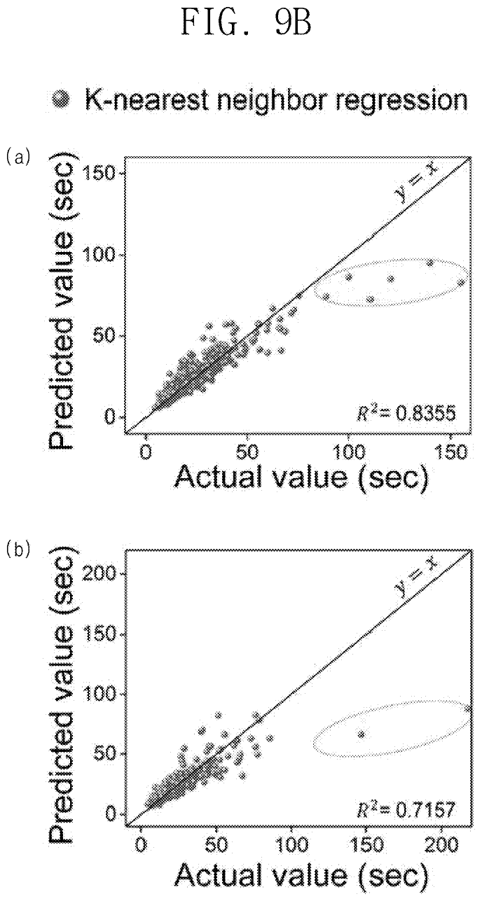

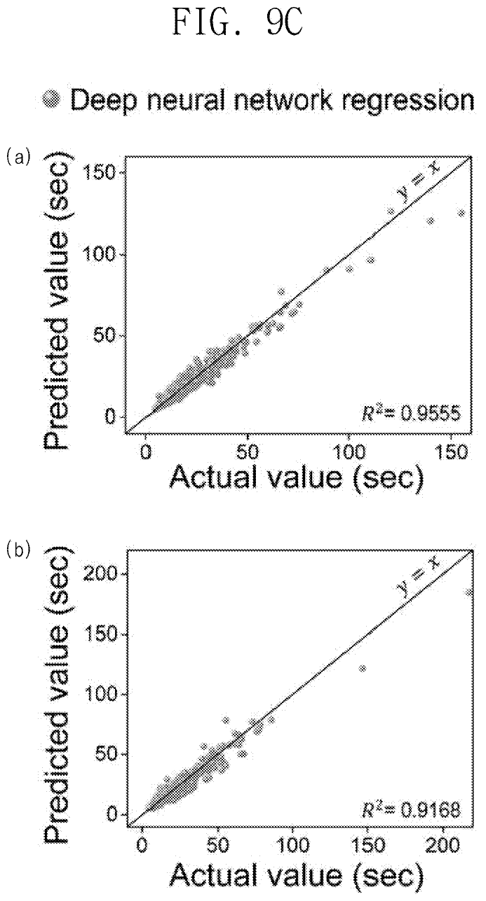

FIGS. 9A to 9C are views obtained by visualizing distribution of results of predicting mean age of air (MAA1 and MAA2) by applying regression models (MLR, KNN, and a DNN) based on the same dataset according to an embodiment of the present invention.

Referring to FIG. 9A, the MLR model was mainly appropriate to a data point with high density of ~50 seconds or less. Therefore, it may be found that MAA prediction for higher values is impossible due to characteristics of the MLR model.

Referring to FIG. 9B, the KNN model exhibited improved prediction performance as compared to the MLR model. However, while prediction performance improved for MAA values between about 50 to 100 seconds, the KNN model failed to accurately predict high MAA values of about 100 seconds or more (see a red dotted line circle). Such a result was obtained because a small number of outliers in which MAA values are sharply increased were included in the training dataset (see FIGS. 5a and 5c). This is a phenomenon that generally occurs in most industrial dataset.

Meanwhile, referring to FIG. 9C, a DNN-based regression model successfully predicted MAA values across an entire range of a figure dataset. Therefore, it may be found that a developed data-based DNN prediction model enables real-time monitoring and accurate advance prediction for individual patients according to indoor ventilation control conditions. This is noteworthy in that the model may contribute to establishing energy-efficient ventilation strategies according to conditions of a patient (e.g., occupancy, health status, and relative importance of air quality).

### Determination of Position of Ventilation Inlet

A position of a ventilation inlet, which has a significant influence on the mean age of air MAA₁ and MAA₂, may be indirectly evaluated by applying a permutation feature importance technique based on a variation in accuracy according to each input variable.

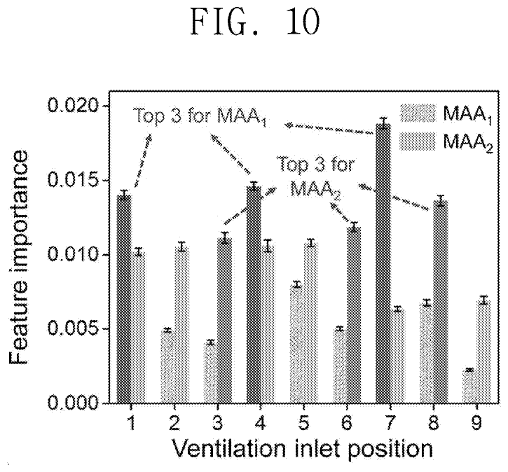

FIG. 10 is a view showing an importance score of an input variable (a flow velocity for each ventilation inlet position), which is derived by applying permutation feature importance to a DNN-based air age prediction model, to prediction of mean age of air (MAA₁ and MAA₂) according to an embodiment of the present invention.

Referring to FIG. 10, for the MAA₁ prediction, Inlets #7, #4, and #1 were found to play the most important role as compared to other variables. The above inlet conditions are positions that directly supplied air to the bed 1 (see FIG. 4), which suggests that interpretation of the air age prediction model was effectively performed. In addition, Inlets #8, #6, and #3 were evaluated as variables having the most important influence on the MAA₂ prediction according to permutation feature importance scores. However, although Inlet #9 is relatively close to the bed 1, Inlet #9 exhibited low contribution, which may be because Inlet #9 is adjacent to an outlet 2 as shown in FIG. 4b.

A pre-trained DNN model (i.e., the air age prediction model) and the permutation feature importance technique may be utilized to evaluate priority of inlet positions affecting each value of the mean age of air, which is difficult to be identified intuitively or directly. Through the above process, an energy-efficient and personalized operating map may be derived.

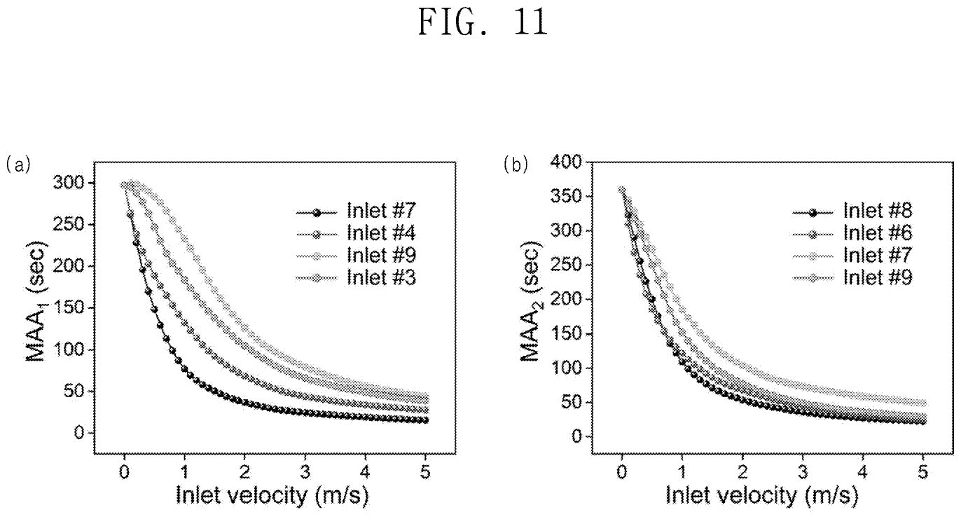

FIG. 11 is a view showing a result of selecting top and bottom variables that have the most influence on each of mean age of air (MAA₁ and MAA₂) by applying permutation feature importance to a DNN-based air age prediction model, and performing the DNN-based air age prediction model again by using only the variables as input values according to an embodiment of the present invention.

Referring to (a) of FIG. 11, MAA₁ prediction results for Inlets #7 and #4 (top two variables) and Inlets #9 and #3 (bottom two variables) within an introduction velocity range of 0 to 5 m/s are shown. As a ventilation velocity increases, indoor air circulation is gradually accelerated, so that an air replacement rate is improved, and the mean age of air is reduced. However, at the same velocity, the top two variables reduced an MAA₁ cost more efficiently than the bottom two variables. For example, when the introduction velocity is 2 m/s, results of about 36.68 seconds, 68.53 seconds, 126.14 seconds, and 104.74 seconds were derived under conditions of Inlets #7, #4, #9, and #3, respectively.

Referring to (b) of FIG. 11, a similar trend was observed for the MAA₂ as the introduction velocity increases, and the top two important variables (Inlets #8 and #6) had a more effective influence on reduction of the MAA₂ than the bottom two conditions (Inlets #7 and #9). It is also noteworthy that while average importance of Inlet #8 is higher, Inlet #6 is more effective in a range of about 0.7 m/s or less, which supports an efficient ventilation system design considering the inlet position and the flow rate (see an intersecting zone).

In addition, as in the example of Inlet #7, an introduction velocity condition may affect both two values of the mean age of air, and the same approach considering overall permutation feature importance scores may be applied when various positions have to be simultaneously considered.

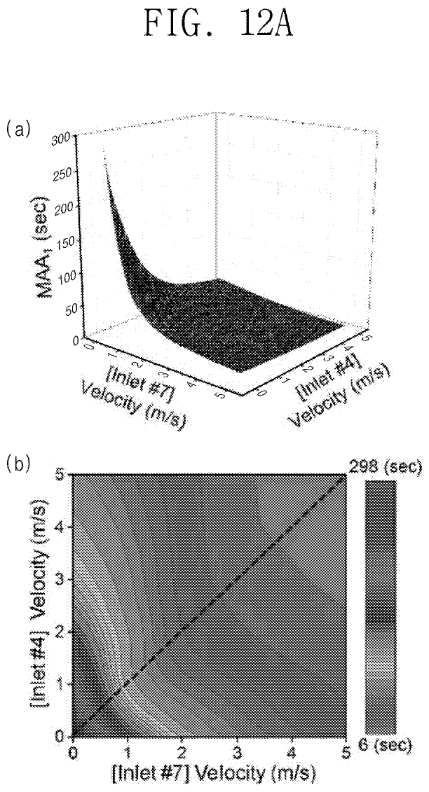

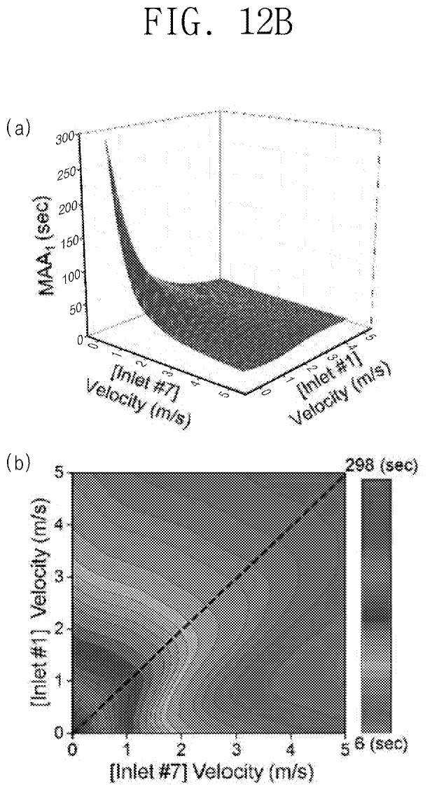

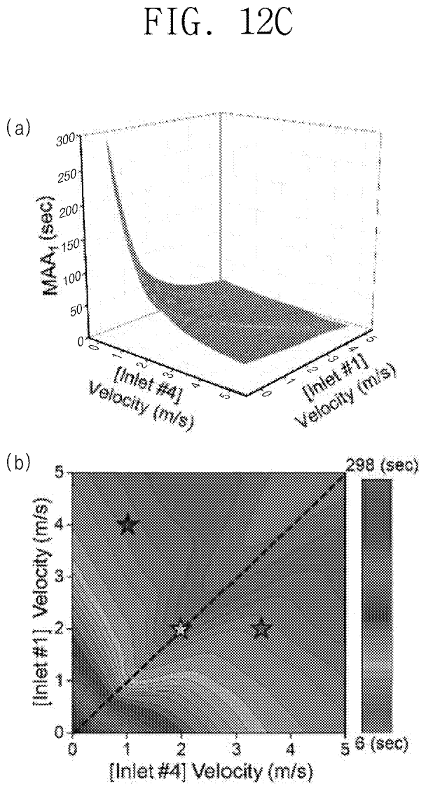

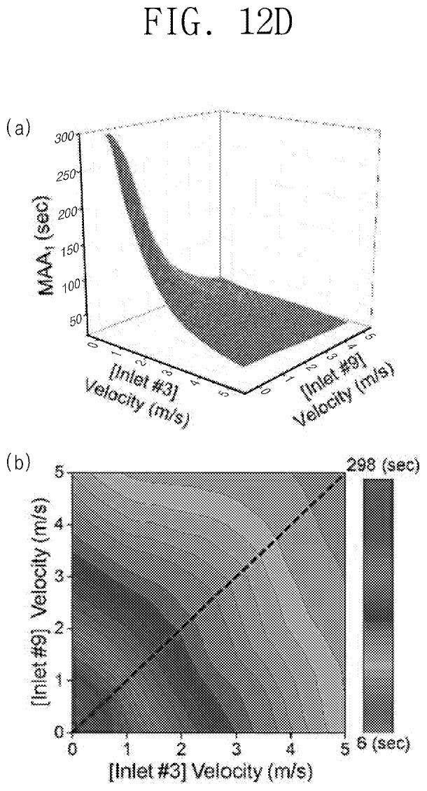

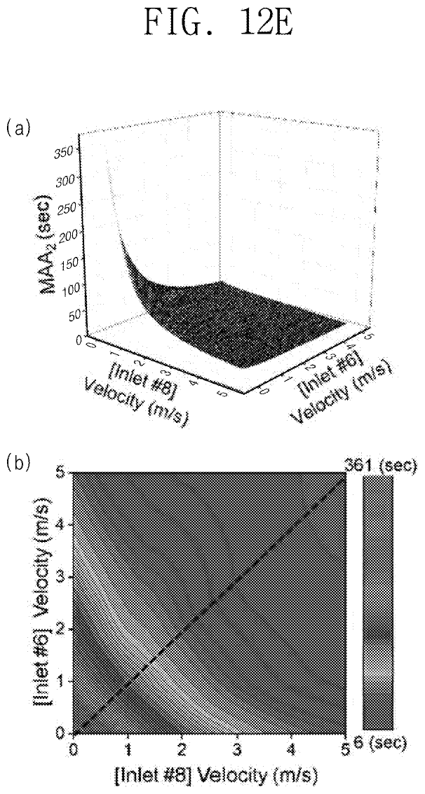

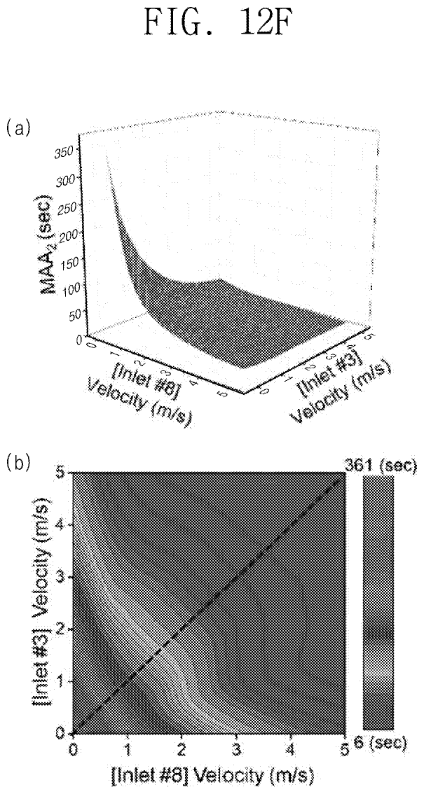

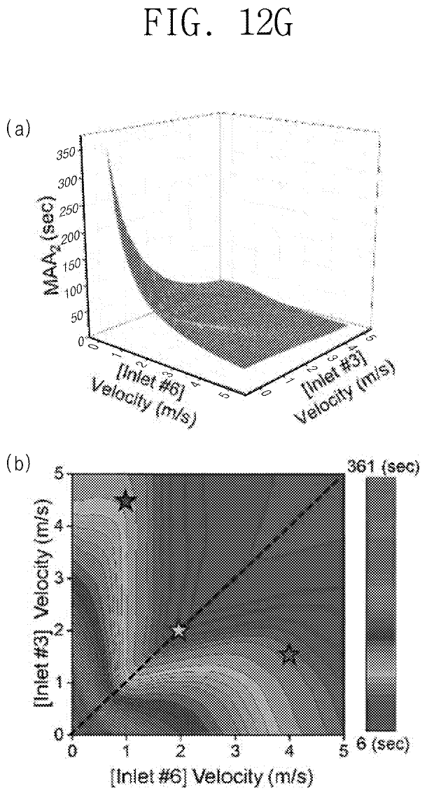

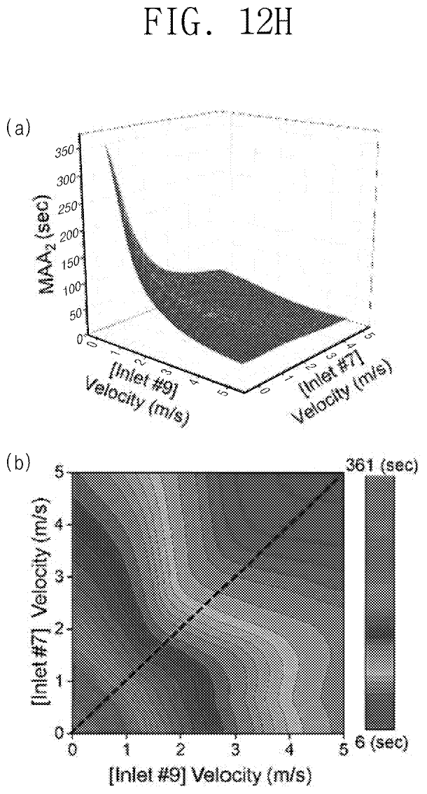

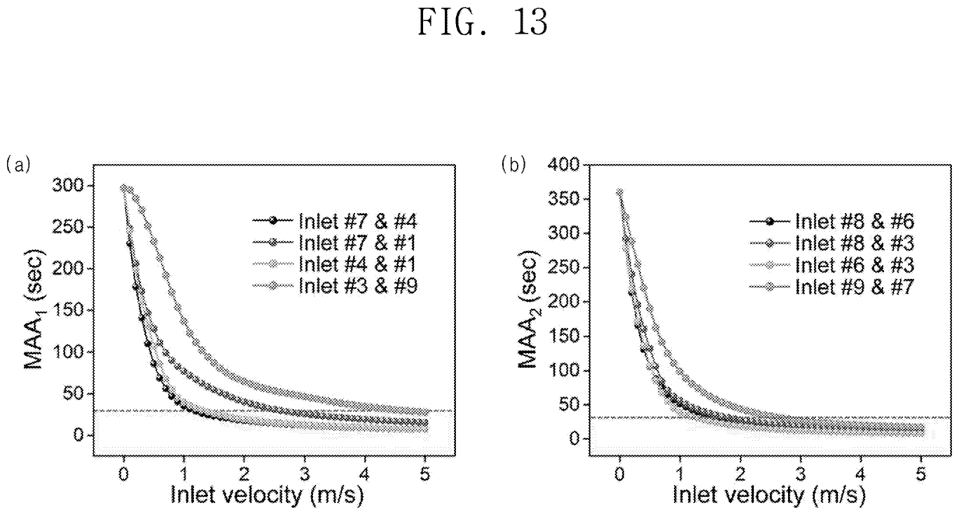

FIGS. 12A to 12H are a view showing prediction results of mean age of air (MAA₁ and MAA₂) according to each inlet velocity variation for a combination of major input variables derived by applying permutation feature importance to an air age prediction model according to an embodiment of the present invention. Predicted values of the mean age of air for two inlet position combinations and an air velocity range of 0 to 5 m/s are shown. For comparison, three pairs of inlet combinations having the greatest influence on the prediction of the mean age of air and two pairs of inlet combinations having the least influence on the prediction of the mean age of air were selected based on PFI scores, and results of predicting mean age of air according to variations in their velocity are shown as graphs.

Referring to FIGS. 12A to 12H, a total of 2601 predictions generated by the data-based DNN model for respective cases were performed only in about 1.11 seconds (~0.4 msec/prediction), which exhibited possibility of real-time monitoring as compared to existing methods. In all cases, the value of the mean age of air decreased as the introduction velocity increases, and different trend maps were formed according to inlet combination conditions.

In particular, referring to FIGS. 12D and 12F, it is shown that it is difficult to achieve low MAA values under high-speed boundary conditions including low-importance input variables. In other words, it is shown that even when a flow velocity is increased by combining low-importance inlets, an effect of lowering the mean age of air is reduced. In particular, referring to (b) of FIG. 12D, it is shown that there is no red region as compared to other graphs. That is, this means that the combination is inefficient for improving introduction air quality.

Meanwhile, a high-efficiency region identified through a color map and a contour boundary line may contribute to implementation of a more efficient air quality management system by establishing a velocity control strategy through a proposed variable importance-based approach.

Referring to (b) of FIG. 12C, the mean age of air MAA₁ exhibits the lowest value of about 18.95 seconds under a condition in which each of flow velocities of Inlets #4 and #1 is set to 2 m/s (a yellow star). Meanwhile, for higher velocity combinations, which are a green star (a condition of 3.5 m/s and 2 m/s) and a blue star (a condition of 1 m/s and 4 m/s), the MAA₁ values increased to about 24.44 seconds and 22.33 seconds, respectively. This suggests that higher introduction velocities of inlets do not always improve air quality, and an air quality improvement effect may vary according to combinations and distribution of a group of candidates of the inlet.

Similarly, referring to (b) of FIG. 12G, the value of the mean age of air MAA₂ was derived as about 18.85 seconds under a condition in which each of flow velocities of Inlets #6 and #3 is set to 2 m/s (indicated by a yellow star). In contrast, under conditions of a blue star (1 m/s and 4.5 m/s) and a green star (4 m/s and 1.5 m/s) in which energy consumption is relatively high due to higher flow velocity combinations, the mean age of air were about 32.41 seconds and 25.62 seconds, respectively.

Next, for further comparison, attention was paid to black dotted lines (an identical introduction velocity condition) shown in (b) of each of FIGS. 12A to 12H. Results of comparing the values of the mean age of air for each combination are shown in FIG. 13.

FIG. 13 is a view showing comparison of variations in mean age of air (MAA₁ and MAA₂) according to an increase in an introduction velocity for various ventilation inlet combinations based on black dotted lines (an identical introduction velocity condition) indicated in (b) of each of FIGS. 12A to 12H according to an embodiment of the present invention.

Referring to FIG. 13, introduction conditions of the mean age of air MAA₁ and MAA₂ according to an increase in an introduction velocity may be easily identified visually. For example, in order to control the value of the mean age of air to 30 seconds or less at each position of the patient, the MAA₁ may be efficiently controlled by applying 1.2 m/s to each of Inlets #7 and #4, and the MAA₂ may be efficiently controlled by applying 1.3 m/s to each of Inlets #6 and #3.

Conversely, in order to obtain the same target values of the MAA₁ and MAA₂, a minimum air velocity of 4.6 m/s is required for Inlets #3 and #9, and a minimum air velocity of 2.7 m/s is required for Inlets #9 and #7. This suggests that higher introduction velocities do not always improve ventilation performance, and efficiency varies according to combinations and arrangement of the inlets.

Consequently, when the real-time air age prediction model proposed herein is used, accurate prediction of the mean age of air may be performed, and the air age prediction model may be effectively utilized to easily establish energy-efficient air quality control strategies based on status or requirements of the patient. In addition, even when the inlet position or the number of hospital beds is changed, it is possible to respond flexibly through adjustment of the number of nodes in the input and output layers and input variable contribution analysis, which shows potential for expansion into a real-time simulation-based HVAC control system.

According to the present invention, in order to predict a mean age of air (MAA), which is an air quality indicator that may not be directly measured, high prediction accuracy was ensured by effectively combining computational fluid dynamics (CFD) models and machine learning-based prediction models.

In particular, unlike conventional researches, according to the present invention, quantitative analysis of contribution of an input variable (e.g., a flow velocity for each ventilation inlet position) was enabled by applying permutation feature importance, which is one of explainable artificial intelligence (XAI).

For future applications, it is necessary to adjust the CFD model to suit actual structural characteristics of indoor spaces and characteristics of ventilation systems, and multifaceted model validation procedures are required to ensure reliability of a proposed workflow.

Furthermore, it is very important in the system for designing the position of the ventilation inlet by using the air age prediction model to develop a more effective air age elements by reflecting prediction model and identify key ventilation control parameters obtainable in an actual environment and input conditions according to a target position.

### Summary of Analysis Results of System According to Example

The present invention proposed a data-based machine learning algorithm and an XAI-based approach in order to implement real-time ventilation monitoring and an efficient operating condition recommendation method. In order to generate dataset, CFD simulation was performed on geometry of an indoor hospital double room. Thereafter, mean air age data for each region was extracted according to inlet conditions. Three different machine learning models were trained, and prediction performance thereof were compared to each other. Among the machine learning models, the DNN model adjusted with a Bayesian optimization algorithm exhibited the highest prediction accuracy, and the MAE, MSE, and R² values were 1.90, 8.70, and 0.9506 for the MAA₁ prediction, respectively. In addition, importance of an input variable was evaluated through a permutation feature importance algorithm, and an output value was predicted. Inlets #7, #4, and #1 were selected as inlet positions that have the greatest influence on MAA₁, and Inlets #8, #6, and #3 were selected as inlet positions that have the greatest influence on MAA₂. Thereafter, a mean air age prediction map was plotted by selecting single and double input characteristics. A time required to predict the mean age of air for 2601 data points was only about 1.11 seconds. Finally, various effective operating conditions were derived and searched for by utilizing single or double introduction conditions according to a permutation feature importance score, thereby presenting energy-efficient operating strategies. In conclusion, the present approach utilizing the proposed workflow provides an alternative capable of rapidly and accurately predicting a value of a mean age of air for each region as compared to existing CFD simulation or less efficient prediction models. Such a result shows potential of the present approach in terms of indoor air quality management and energy efficiency improvement of an HVAC system.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

What is claimed is:

1. A system for designing a position of a ventilation inlet by using an air age prediction model, the system comprising:
a data input unit for inputting position information of a group of candidates for the ventilation inlet based on a position of a facility within a target space; and
a ventilation inlet position determination unit for determining an installation position of the ventilation inlet by using information of the facility and the position information of the group of candidates for the ventilation inlet as input data, and outputting mean air age data at a periphery of the facility according to a variation in a flow velocity of air introduced into the ventilation inlet to the air age prediction model.

2. The system of claim 1, further comprising:
a training data construction unit for generating the mean air age data at the periphery of the facility as training data by applying boundary information of the target space and boundary information of the group of candidates for the ventilation inlet to computational fluid dynamics (CFD); and
a prediction model determination unit for determining one of a plurality of machine learning models as the air age prediction model by individually training the training dataset through the machine learning models, and evaluating training performance.

3. The system of claim 2, wherein the machine learning model includes multiple linear regression (MLR), K-nearest neighbor (KNN), and a deep neural network (DNN).

4. The system of claim 2, wherein the prediction model determination unit determines the air age prediction model by calculating a coefficient of determination (R²), a mean absolute error (MAE), and a mean squared error (MSE) for training performance of each of the machine learning models, and using the coefficient of determination (R²), the mean absolute error (MAE), and the mean squared error (MSE) as evaluation indicators.

5. The system of claim 1, wherein the ventilation inlet position determination unit determines the installation position of the ventilation inlet according to contribution to the mean air age data among the group of candidates for the ventilation inlet by applying permutation feature importance (PFI) to the air age prediction model.

6. The system of claim 1, wherein the target space includes a hospital room,
the facility includes a patient bed, and
the information of the facility includes position information, width information, and height information of the patient bed.

7. A method for designing a position of a ventilation inlet by using an air age prediction model, the method comprising:
a data input step of inputting position information of a group of candidates for the ventilation inlet based on a position of a facility within a target space; and
a ventilation inlet position determination step of determining an installation position of the ventilation inlet by using information of the facility and the position information of the group of candidates for the ventilation inlet as input data, and outputting mean air age data at a periphery of the facility according to a variation in a flow velocity of air introduced into the ventilation inlet to the air age prediction model.

8. The method of claim 7, further comprising:
a training data construction step of generating the mean air age data at the periphery of the facility as training data by applying boundary information of the target space and boundary information of the group of candidates for the ventilation inlet to computational fluid dynamics (CFD); and
a prediction model determination step of determining one of a plurality of machine learning models as the air age prediction model by individually training the training dataset through the machine learning models, and evaluating training performance.

9. The method of claim 8, wherein the machine learning model includes multiple linear regression (MLR), K-nearest neighbor (KNN), and a deep neural network (DNN).

10. The method of claim 8, wherein in the prediction model determination step, the air age prediction model is determined by calculating a coefficient of determination (R²), a mean absolute error (MAE), and a mean squared error (MSE) for training performance of each of the machine learning models, and using the coefficient of determination (R²), the mean absolute error (MAE), and the mean squared error (MSE) as evaluation indicators.

11. The method of claim 7, wherein in the ventilation inlet position determination step, the installation position of the ventilation inlet is determined according to contribution to the mean air age data among the group of candidates for the ventilation inlet by applying permutation feature importance (PFI) to the air age prediction model.

12. The method of claim 7, wherein the target space includes a hospital room,
the facility includes a patient bed, and
the information of facility includes position information, width information, and height information of the patient bed.
